(19) United States
(12) Patent Application Publication
(10) Pub. No.: US 2010/0080424 A1
(43) Pub. Date: Apr. 1, 2010

(54) FINGERPRINT AUTHENTICATION SYSTEM AND OPERATION METHOD

(75) Inventor: Miwa Hayashi, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/564,079

(22) Filed: Sep. 22, 2009

(30) Foreign Application Priority Data
Sep. 26, 2008 (JP) 2008-248225

(51) Int. Cl. G06K 9/00; G08B 23/00

(52) U.S. Cl. 382/124; 340/573.1

(57) ABSTRACT

A fingerprint authentication system with a slide sensor provides guidance to help the user swipe his or her fingertip across the slide sensor at the ideal speed by modulating a pulse signal according to the swipe speed and converting the modulated pulse signal to an audible tone with a pitch that varies with the swipe speed, or to an equivalent visible display.

### BACKGROUND OF THE INVENTION

1. Field of the Invention

The present invention relates to a fingerprint authentication system that provides feedback to guide a user in sliding his or her fingertip across a slide sensor at the correct speed.

2. Description of the Related Art

Fingerprint authentication is a type of biometric authentication in which an individual is identified by the shallow pattern of ridges on the skin of a finger. The finger is placed on the surface of a scanning sensor and the identification is made by determining whether the scanned fingerprint pattern matches a prestored pattern. Fingerprint scanning sensors can be generally classified as touch sensors, also referred to as surface sensors or area sensors, and slide sensors, also referred to as swipe sensors or sweep sensors.

A touch sensor captures an image of the entire fingerprint all at once. A slide sensor, as shown in FIG. 2, captures successive rectangular slices of the fingerprint image (referred to as slice images below) as the user swipes (slides) his or her finger across the sensor. Slide sensors have the advantage of smaller size and lower cost, but they are harder to use, because the sensing operation may fail if the finger does not slide at the proper speed.

Reconstruction of the fingerprint image from the successive slices captured by a slide sensor requires some overlap between mutually adjacent slice images, so that the images can be stitched together by matching the overlapping parts. If the finger is swiped too quickly, leaving gaps between the slice images, accurate reconstruction becomes difficult or impossible. The overlap is preferably not too large, however, because the overlapping areas are reconstructed, for example, by an averaging process that tends to blur the fingerprint image. The blur becomes increasingly serious as the number of overlapping slices increases. Accordingly, the finger should not be swiped too slowly.

One way to deal with fast and slow swipe speeds would be to adjust the interval at which slice images are captured to suit the swipe speed. The range of allowable swipe speeds can be expanded in this way, but the capture rate has an upper limit set by hardware or software specifications, so the capture interval is only adjustable up to a certain point. In addition, even if the capture interval is adjusted, for consistent image quality the finger still needs to be swiped at a substantially constant speed.

For these reasons, it becomes necessary for the user to control the swipe speed. Visual perception of swipe speed, however, is highly subjective and is only approximate at best. It is hard for the user to tell, just by watching the fingertip move, whether the fingertip is moving at a constant speed, and whether the speed is too fast or too slow. Some type of guidance is necessary. In the absence of such guidance, finger swiping becomes a difficult skill that is not easy to learn.

The swiping motion must also be continuous. If the user inadvertently takes his or her finger off the sensor during the swipe, the reconstructed fingerprint image will have a discontinuity that will normally result in failure of authentication, or possibly in false authentication if the authentication process is carried out using only the part of the fingerprint image preceding or following the discontinuity. Here too, there is a need for user guidance.

Japanese Patent Application Publication No. 2007-286890 discloses a fingerprint authentication system that computes a mean difference between corresponding pixel values in overlapping areas. If the mean difference is too large, the user is warned that the swipe speed is too fast. This warning, however, fails to help the user maintain a constant swipe speed, or maintain continuous contact with the sensor.

Japanese Patent Application Publication No. 2005-143890 (now Japanese Patent No. 3924558) discloses a fingerprint authentication system that uses beep tones and visual displays to make the user aware of incorrect swiping motions, but these indications require considerable use of the system's computational resources, and require considerable interpretation on the user's part.

There is a need for a simpler and intuitive way to guide the user in maintaining a constant, continuous swipe.

### SUMMARY OF THE INVENTION

An object of the present invention is to provide the user of a fingerprint authentication system with simple and intuitive swipe guidance.

Another object of the invention is to provide such swipe guidance with minimal use of computing resources.

The invention provides a fingerprint authentication system including a slide sensor that captures successive slice images as the user's fingertip is swiped across the slide sensor. A fingerprint reconstruction processor reconstructs a fingerprint image from the slice images. A fingerprint authentication processor authenticates the fingerprint by comparing the fingerprint image with a prestored image.

A swipe speed calculator periodically calculates the swipe speed. The swipe speed may be calculated from information output periodically by the fingerprint reconstruction processor, indicating the number of image lines reconstructed so far. Alternatively, the swipe speed calculator may calculate the swipe speed by comparing successive slice images.

A pulse width modulator modulates a pulse signal responsive to the calculated swipe speed. A transducer converts the modulated pulse signal to audible or visible output.

### BRIEF DESCRIPTION OF THE DRAWINGS

In the attached drawings:

FIG. 1 is a block diagram illustrating of the structure of the fingerprint authentication system in an embodiment of the invention;

FIG. 2 illustrates the operation of a slide sensor;

FIGS. 3 and 4 illustrate the operation of the fingerprint authentication system in FIG. 1; and

FIG. 5 is a block diagram illustrating of the structure of the fingerprint authentication system in another embodiment of the invention.

### DETAILED DESCRIPTION OF THE INVENTION

Embodiments of the invention will now be described with reference to the attached drawings, in which like elements are indicated by like reference characters.

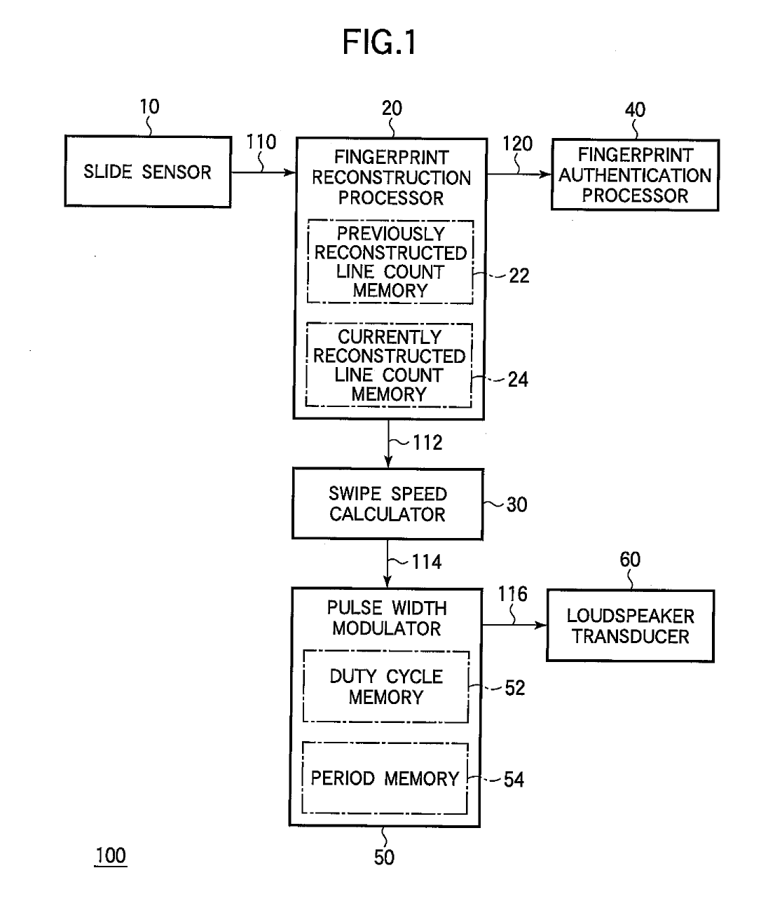

Referring to FIG. 1, in one embodiment the fingerprint authentication system 100 comprises a slide sensor 10, a fingerprint reconstruction processor 20, a swipe speed calculator 30, a fingerprint authentication processor 40, a pulse width modulator 50, and a loudspeaker transducer 60, referred to below simply as a loudspeaker 60.

In this embodiment, as the user's fingertip is swiped across the slide sensor 10, the fingerprint image is gradually reconstructed. During the swipe, the swipe speed is determined from the number of reconstructed lines of the image, and the loudspeaker 60 produces an audible tone that varies in pitch according to the swipe speed.

As the fingertip moves across the slide sensor 10, the slide sensor 10 captures successive slices of the fingerprint image and sends the slice images 110 to the fingerprint reconstruction processor 20. The fingerprint reconstruction processor 20 detects slice overlap and stitches the slices together at the overlapping parts to build up the reconstructed fingerprint image. During this process, the fingerprint reconstruction processor 20 keeps count of the number of image lines (pixel lines) reconstructed so far and generates speed calculation information 112 including these line counts and time information. The speed calculation information 112 is supplied to the swipe speed calculator 30. At the end of the swipe, the reconstructed fingerprint image 120 is sent to the fingerprint authentication processor 40.

The swipe speed calculator 30 calculates the swipe speed from the speed calculation information 112 received from the fingerprint reconstruction processor 20 and sends the calculated swipe speed 114 to the pulse width modulator 50. The pulse width modulator 50 generates a pulse signal, modulates the waveform of the pulse signal according to the swipe speed 114, and sends the modulated pulse signal 116 to the loudspeaker 60. The loudspeaker 60 converts the modulated pulse signal 116 to an audible tone.

The fingerprint reconstruction processor 20 includes a previously reconstructed line count memory 22 and a currently reconstructed line count memory 24. When the fingerprint reconstruction processor 20 places a new value in the currently reconstructed line count memory 24, it moves the previous value of the currently reconstructed line count memory 24 into the previously reconstructed line count memory 22.

The pulse width modulator 50 includes a duty cycle memory 52, a period memory 54, and a pulse generator (not shown) that generates a pulse signal with the period and duty cycle stored in these memories 52, 54. This pulse signal is output as the modulated pulse signal 116.

The fingerprint reconstruction processor 20, swipe speed calculator 30, fingerprint authentication processor 40, and pulse width modulator 50 may be integrated into a single integrated circuit. The integrated circuit may be an application specific integrated circuit such as a biometric coprocessor, or a general-purpose integrated circuit such as a microcontroller. Alternatively, the fingerprint reconstruction processor 20 and fingerprint authentication processor 40 may be integrated into a biometric coprocessor and the swipe speed calculator 30 and pulse width modulator 50 may be integrated into a microcontroller, or various other integrated circuit combinations may be used. The memories 22, 24, 52, 54 in FIG. 1 may be memory areas or registers in these integrated circuits.

The operation of the fingerprint authentication system 100 will now be described.

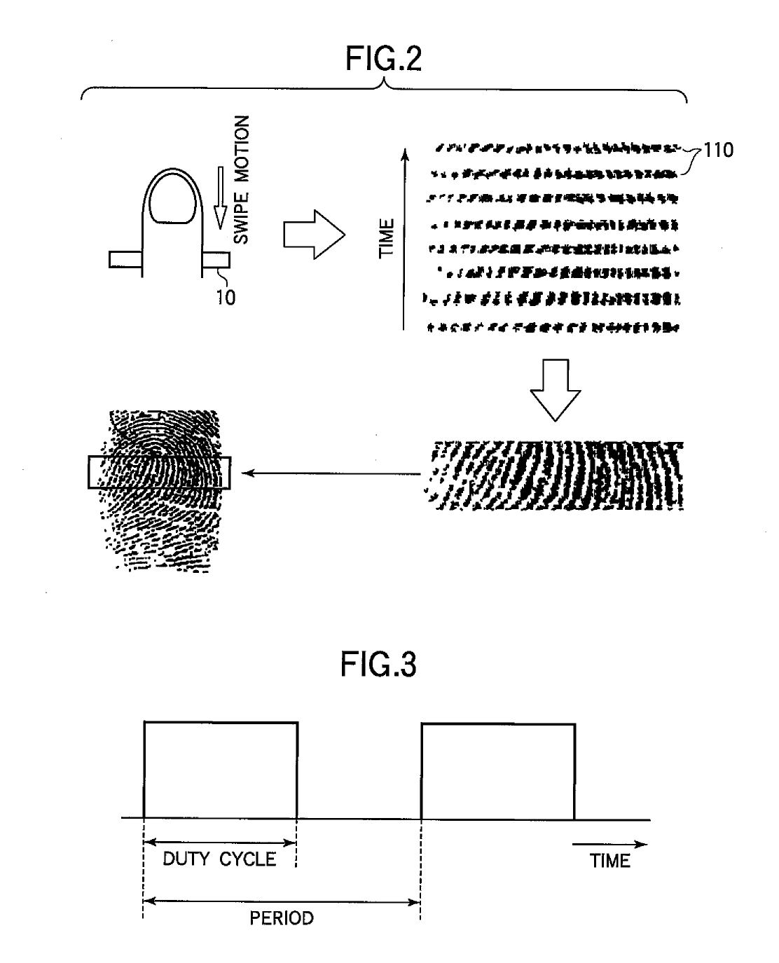

FIG. 2 illustrates how a fingerprint image is built up. As the fingertip moves in the direction indicated by the arrow, at regular intervals of time, the slide sensor 10 captures a rectangular image of the part of the fingertip currently over the sensor window, and sends it as a slice image 110 to the fingerprint reconstruction processor 20. The fingerprint reconstruction processor 20 compares successive slice images to find their overlapping parts. In the overlapping parts, for example, the reconstruction processor 20 computes new pixel values by averaging the values of overlapping pixels.

The reconstruction processor 20 thereby stitches the slices together into a reconstructed fingerprint image, using the computed average pixel values in the overlapping parts and the pixel values output by the slide sensor 10 in the non-overlapping parts. FIG. 2 schematically shows the stage at which eight slice images 110 have been stitched together to reconstruct one part of the entire fingerprint.

When the fingertip leaves the slide sensor 10, the reconstruction process ends and the reconstructed fingerprint image 120 is sent to the fingerprint authentication processor 40 in FIG. 1. The fingerprint authentication processor 40 compares the reconstructed fingerprint image 120 with one or more registered fingerprint image patterns. Authentication succeeds if a matching pattern is found.

From time to time the fingerprint reconstruction processor 20 sends the swipe speed calculator 30 speed calculation information 112 including the number (PL) stored in the previously reconstructed line count memory 22, the number (CL), and the time interval (TI) that elapsed between the times when these two line counts were obtained.

The speed calculation information 112 indicates that (CL−PL) new lines were added to the reconstructed image during the time interval TI. The line size has a fixed value determined by the pixel density or dot density of the sensor, typically measured in dots per inch (dpi). The swipe speed calculator 30 calculates the swipe speed (SS) as follows:

SS=(CL−PL)/TI

The calculated swipe speed SS is sent as swipe speed 114 to the pulse width modulator 50.

The time interval TI may have a fixed value predetermined on the basis of experiment, or a variable value measured by a timer. If TI is fixed, it may be omitted from the speed calculation information 112; the swipe speed may be set equal to the difference in line counts (CL−PL). If the intervals at which the slide sensor 10 captures slice images are fixed but the reconstruction time interval TI is variable, TI may be expressed as the number of slice images 110 received between the times at which PL and CL lines were reconstructed, without using a timer.

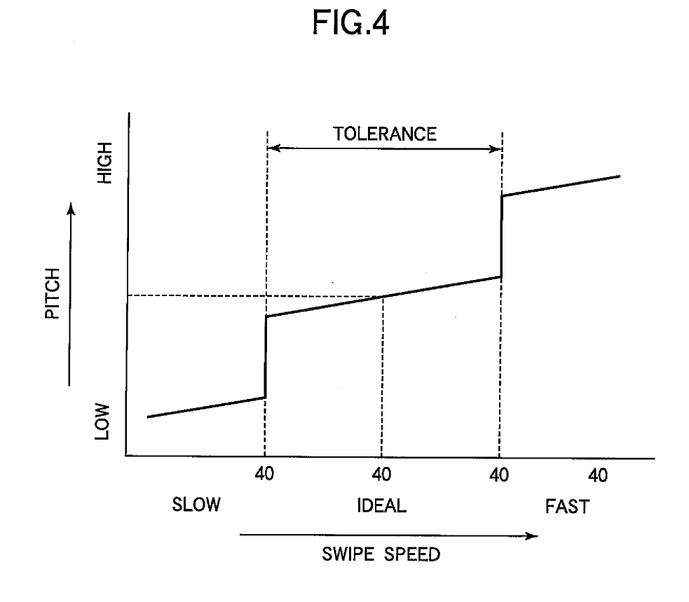

The modulated pulse signal 116 output by the pulse width modulator 50 is used as an audio signal to drive the loudspeaker 60. This signal 116 accordingly has a rectangular waveform as shown in FIG. 3, instead of the usual sinewave audio waveform.

Pulse width modulation (PWM) refers generally to the production of a repetitive pulse signal with constant pulse frequency and amplitude and variable pulse width. The pulse width is usually expressed as a percentage of the pulse period and is referred to as the duty cycle, as indicated in FIG. 3. A greater pulse width (duty cycle) produces a greater total amount of output, so PWM is often used to control the brightness of light emitting diodes. Many microcontrollers and other integrated circuits include pulse width modulators that can produce PWM output.

These pulse width modulators usually include a register that can be used to specify the frequency of the PWM signal. In the present embodiment, the period memory 54 has this function, and the pulse width modulator 50 is used simply as a circuit that can produce a pulse signal with a specified period and duty cycle. An appropriate duty cycle value is stored in the duty cycle memory 52 and left constant. The value set in the period memory 54 is varied according to a desired relation between swipe speed and tone frequency. The period and accordingly the frequency of the modulated pulse signal 116 thus varies according to the swipe speed 114, and the loudspeaker 60 produces a tone with a pitch that varies according to the swipe speed.

FIG. 4 shows an exemplary relationship between the frequency of the pulse signal 116 or the tone pitch and the swipe speed. The ideal swipe speed is assumed to be forty centimeters per second (40 cm/sec). Near the ideal value, the tone pitch varies linearly with the swipe speed: if the swipe speed becomes higher or lower than the ideal value, the tone pitch becomes higher or lower accordingly.

The swipe speed need not have exactly the ideal value; there is a specified tolerance range within which accurate fingerprint reconstruction is possible. In FIG. 4 the tolerance range is assumed to be 30 cm/sec to 50 cm/sec. If the swipe speed goes above or below this range, the tone pitch is changes abruptly, as an alarm indicating that the swipe speed is out of the tolerance and the user should quickly take corrective action.

The ideal sweep speed and tolerance range may be determined through experiments. An appropriate fixed duty cycle and an appropriate relation between swipe speed and tone frequency may also be selected on the basis of experiments.

The loudspeaker 60 may start tone output at the moment of arrival of the first slice image, even before the first speed calculation is made. In this case, since the swipe speed tends to be slow when the finger starts sliding, the pulse width modulator 50 may set a high initial value in the period memory 54, to produce a low-pitched initial tone.

Alternatively, tone output may begin even before the first slice image is captured, and the pulse width modulator 50 may set an initial period value corresponding to the ideal swipe speed. As soon as enough slices have been captured to calculate the swipe speed, the period value is updated according to the calculated speed, and the tone pitch changes accordingly. From the direction of the change in tone pitch, the user can tell whether the swipe speed is too fast or too slow.

At the end of the swiping motion, the pulse width modulator 50 halts output of the modulated pulse signal 116 and tone output stops. The pulse width modulator 50 also halts output of the modulated pulse signal 116 if the finger is lifted from the slide sensor 10 before the swipe is completed.

By listening to the tone output from the loudspeaker 60, the user can easily tell when the swipe speed is out of tolerance, and whether the speed is too high or too low. With this audible guidance, even novice users can keep their swipe speed within tolerance for a sufficiently high proportion of the time to produce an authenticatable fingerprint image. After becoming accustomed to the tone, most users will be able to keep their swipe speed consistently close to the ideal speed, producing ideal or nearly ideal fingerprint images.

If the user's fingertip leaves the slide sensor 10 during a swipe, the cessation of the tone informs the user of this in an immediately comprehensible way.

More generally, if for any reason the fingerprint reconstruction processor finds, during the fingerprint reconstruction process, that it is unable to reconstruct the fingerprint image, the pulse width modulator 50 immediately ceases output of the modulated pulse signal 116 to halt the tone and thereby inform the use that the swipe has failed.

In this embodiment, the user's task is simply to slide his or her finger in a way that produces a steady, constant tone. This type of feedback is simpler and more intuitive than the warning messages, warning beeps, and other type of feedback found in the prior art.

A further advantage of the above embodiment is that the use of a pulse width modulator eliminates the need to store sound waveform data in the system, thereby conserving memory resources.

The ideal swipe speed can be calculated from system parameters such as the height of the slice images, the number of overlapping pixel lines required to stitch two mutually adjacent slice images together, and rate at which the slide sensor 10 can capture the slice images. If engineering changes are made during commercial production by changing the type of slide sensor used or changing one of the processors, the ideal swipe speed may change, but the tone pitch that indicates the ideal swipe speed can be kept the same by calculating the ideal swipe speed from the new system parameters and programming the pulse width modulator to produce a speed-pitch relation like the one in FIG. 3, centered on the new ideal sweep speed.

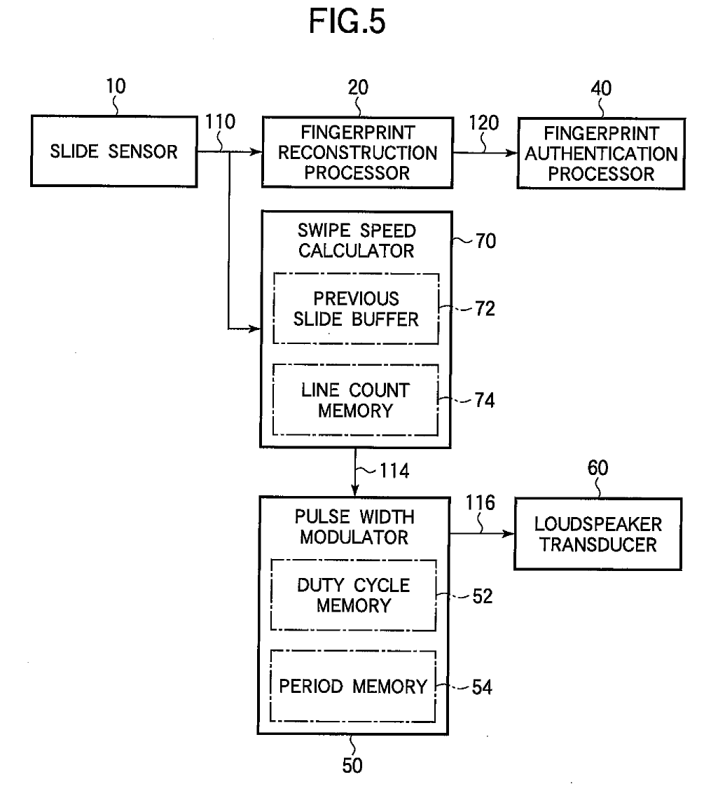

FIG. 5 illustrates a variation of the preceding embodiment in which the swipe speed calculator 30 in FIG. 1 is replaced by a swipe speed calculator 70 that receives the slice images 110 from the slide sensor 10, but does not receive any speed calculation information from the fingerprint reconstruction processor 20. The swipe speed calculator 70 includes a previous slice buffer 72 and a line count memory 74. After processing a slice image received from the slide sensor 10, the swipe speed calculator 70 stores the slice image 110 in the previous slice buffer 72. Upon receiving the next slice image 110, the swipe speed calculator 70 compares it with the image stored in the previous slice buffer 72, determines the number of lines of pixels in the new slice image that do not correspond to any part of the image stored in the previous slice buffer 72, and stores that number in the line count memory 74. The swipe speed calculator 70 then calculates the swipe speed 114 from the values stored in the line count memory 74.

This variation is useful when, for example, the fingerprint reconstruction processor 20 and authentication processor 40 are integrated into a biometric coprocessor that does not provide speed calculation information during a swipe.

The swipe speed calculated by the swipe speed calculator 70 may be fed back to the fingerprint reconstruction processor. If the swiping motion temporarily stops, for example, the reconstruction process may temporarily halt, and then resume when the swiping motion resumes.

In another variation of the preceding embodiment, the pulse width modulator 50 modulates both the period and duty cycle of the PWM waveform.

In yet another variation, the loudspeaker transducer 60 is replaced with an optical transducer comprising, for example, a liquid crystal or one or more light emitting diodes (LEDs). In this variation the pulse width modulator 50 may leave the value in the period memory 54 constant and modulate only the duty cycle of the PWM signal 116.

The optical transducer may convert the PWM signal to an analog voltage, then indicate the analog voltage as, for example, the height of a lighted bar, in which case the user's task is to keep the lighted bar at the proper height.

Alternatively, the modulated pulse signal may directly drive an LED, thereby modulating the brightness of the LED. In this case the optical transducer may include two LEDs, one of which is left at the brightness indicating the ideal swipe speed while the other indicates the actual swipe speed. The user's task is to keep the two LEDs at the same brightness level.

Those skilled in the art will recognize that further variations are possible within the scope of the invention, which is defined in the appended claims.

What is claimed is:

1. A fingerprint authentication system comprising:
a slide sensor for capturing successive slice images of a fingerprint as a fingertip is swiped across the slide sensor;
a fingerprint reconstruction processor for reconstructing a fingerprint image from the slice images;
a fingerprint authentication processor for authenticating the fingerprint by comparing the fingerprint image with a prestored image;
a swipe speed calculator for periodically calculating a swipe speed indicating a speed at which the fingertip is moving across the slide sensor;
a pulse width modulator for modulating a pulse signal responsive to the calculated swipe speed; and
a transducer for converting the modulated pulse signal to audible or visible output.

2. The fingerprint authentication system of claim 1, wherein as the fingertip is swiped across the slide sensor, the fingerprint reconstruction processor periodically outputs speed calculation information indicating a number of lines of the fingerprint image reconstructed so far, and the swipe speed calculator calculates the swipe speed from the speed calculation information.

3. The fingerprint authentication system of claim 2, wherein the swipe speed calculator calculates the swipe speed at regular intervals.

4. The fingerprint authentication system of claim 1, wherein the swipe speed calculator receives the slice images from the slide sensor and calculates the swipe speed by comparing the slice images.

5. The fingerprint authentication system of claim 4, wherein the swipe speed calculator compares a current slice image with a preceding slice image and determines a number of lines in the current slice image not matching any lines in the preceding slice image.

6. The fingerprint authentication system of claim 1, wherein before the fingertip is swiped across the slide sensor, the pulse width modulator modulates the pulse signal to represent an ideal swipe speed.

7. The fingerprint authentication system of claim 1, wherein the pulse width modulator modulates a period or frequency of the pulse signal.

8. The fingerprint authentication system of claim 1, wherein the pulse width modulator modulates a duty cycle of the pulse signal.

9. The fingerprint authentication system of claim 1, wherein the pulse width modulator shuts off the pulse signal when reconstruction of the fingerprint image becomes impossible.

10. The fingerprint authentication system of claim 1, wherein the pulse width modulator shuts off the pulse signal when the fingertip leaves the slide sensor.

11. The fingerprint authentication system of claim 1, wherein the transducer comprises a loudspeaker.

12. The fingerprint authentication system of claim 1, wherein the transducer comprises a light-emitting diode.

13. The fingerprint authentication system of claim 1, wherein the transducer comprises a liquid crystal.

14. The fingerprint authentication system of claim 1, wherein at least two of the fingerprint reconstruction processor, the fingerprint authentication processor, the swipe speed calculator, and the pulse width modulator are combined into a single integrated circuit.

15. A method of operating a fingerprint authentication system for authenticating a fingerprint by using a slide sensor, comprising steps of:
capturing successive slice images of a fingerprint as a fingertip is swiped across the slide sensor;
reconstructing a fingerprint image from the slice images;
authenticating the fingerprint by comparing the fingerprint image with a prestored image;
calculating a swipe speed from the slice images;
modulating a pulse signal responsive to the calculated swipe speed; and
converting the modulated pulse signal to audible or visible output.

16. The method of claim 15, further comprising periodically generating speed calculation information indicating a number of lines of the fingerprint image reconstructed so far, the swipe speed being calculated from the speed calculation information.

17. The method of claim 15, wherein calculating the swipe speed further comprises comparing the slice images.

18. The method of claim 15, further comprising modulating the pulse signal to represent an ideal swipe speed before the fingertip is swiped across the slide sensor.

19. The method of claim 15, further comprising shutting off the pulse signal when reconstruction of the fingerprint image becomes impossible.

20. The method of claim 15, wherein converting the modulated pulse signal comprises converting the modulated pulse signal to a tone having a pitch that varies responsive to the swipe speed.
